(19) United States
(12) Patent Application Publication
(10) Pub. No.: US 2006/0291413 A1
(43) Pub. Date: Dec. 28, 2006

(54) System for the dynamic allocation of carrier frequencies to a access points of a wireless local area network (wlan)

(75) Inventors: Daniel Rossier, Belfaux (CH); Sacha Varone, Vetroz (CH); Jean-Federic Wagen, Neyruz (CH); Vincenzo Inguscio, Delemont (CH); Eric Marchon, Posieux (CH); Fiorenzo Gamba, St-Aubin (CH)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Swisscom AG, Bern (CH)

(21) Appl. No.: 10/557,835

(22) PCT Filed: May 18, 2004
(86) PCT No.: PCT/EP04/50838

§ 371 Date: Nov. 21, 2005

(30) Foreign Application Priority Data
May 21, 2003 (EP) 03405356.1

(51) Int. Cl. H04Q 7/00

(52) U.S. Cl. 370/329; 370/338

(57) ABSTRACT

A computer-based system for dynamic assignment of carrier frequencies to computerized access points of a wireless local area network (WLA) is connected to the access points via a communication connection. Present operational values, such as the present number of associated users and the present number of received faulty and errorless data packets, are captured from the access points via the communication connection by autonomous agent modules of the computer-based system. In the computer-based system, individual weighting factors for the access points are calculated, based on the captured operational values. Access point data about the access points, which include present carrier frequencies and weighting factors, are stored in the computer-based system. Based on the stored access point data, optimal carrier frequencies, or respectively radio frequency channels, are determined in the computer-based system to reduce instances of interference between the access points, and are set in the access points via the communication connection. Optimal carrier frequencies, or respectively radio frequency channels, can thus be determined and set in the access points without resources of the local mobile radio network having to be used for this purpose and without changes having to be made at the access points.

### TECHNICAL FIELD

The present invention relates to a system for dynamic assignment of carrier frequencies to access points of a wireless LAN. The invention relates in particular to a computer-based system for dynamic assignment of carrier frequencies of a wireless local area network as well as a computer program product for control of one or more processors of such a computer-based system.

### STATE OF THE ART

Wireless local area networks, so-called WLAN, are being used more and more in the public sphere, where they enable access for mobile users to computer systems, databases, communication networks and data networks, in particular the Internet. Using their terminals, the mobile users gain access to a wireless local area network via an access point, a so-called AP. The terminals are, for example, laptop or palmtop computers equipped with a communication module for wireless local area networks. To enable access to a wireless local area network with complete coverage in an extended geographic area, a multiplicity of computerized access points are provided, each covering a subarea. The wireless areas of neighboring access points typically overlap. Although the access points have a plurality of selectable radio frequency channels with different carrier frequencies, interference problems often arise nevertheless between nearby access points, on the one hand because the number of available radio frequency channels is limited, and, on the other hand, because the signal bandwidth of the various radio frequency channels can partially overlap. For example, the IEEE standard 802.11 is the most frequently used standard at the present time for the access points of the wireless local area networks. The presently used frequency plan according to this standard calls for eleven or thirteen radio frequency channels whose signal bandwidths partially overlap. Only three radio frequency channels are provided for that do not interfere with one another: in Europe these are usually the channels 1, 7 and 13; in the USA these are usually the channels 1, 6 and 11. For media access, the effects of radio interference are usually mitigated through special mechanisms, for example through Carrier Sense Multiple Access/Collision Avoidance (CSMA/CA), but this takes place at the expense of transmission capacity. In order to avoid neighboring access points from jamming one another through radio interference, the access points are often positioned with the aid of simulation programs that model the course of electromagnetic fields. Such simulation programs require however a detailed description of the vicinity and the topology. Moreover such methods are not especially suitable for taking into account the dynamically changing traffic in a wireless local area network, and offer no possibilities of adapting already positioned access points to changed conditions.

Described in the patent application EP 1 257 092 are a method and specially adapted access points for the dynamic selection of carrier frequencies in access points of a wireless local area network. According to EP 1 257 092, the computerized access points monitor their traffic load, and exchange information about their traffic load with nearby access points. According to EP 1 257 092, interference parameters for the various radio frequency channels are calculated in the access points, and optimal radio frequency channels are selected based thereon. According to EP 1 257 092, an access point has the possibility to ask a neighboring access point to swap the presently used radio frequency channels. Another method in which radio frequency channels are dynamically selected by special software modules in the access points is described in the patent application EP 1 257 090. The methods according to EP 1 257 092 and EP 1 257 090 have the drawback that the computerized access points must be provided with supplementary software modules deviating from the standard design. In addition, the methods according to EP 1 257 092 and EP 1 257 090 are carried out continuously, which, when changing the radio frequency channel, can lead to a mobile terminal switching to another access point because of temporary signal loss.

Described in the patent application US 2002/0060995 are a system and method for dynamically selecting radio frequency channels between the access point and terminals of a wireless local area network. According to US 2002/0060995, upon request of the AP, a terminal measures the signal strength and the bit error rate on a multiplicity of channels with nearby access points, and transmits the measuring results to the requesting access point. According to US 2002/0060995, the access point selects, if necessary, a new radio frequency channel on the basis of the received measuring results. The method according to US 2002/0060995 has the drawback that both the computerized access points and the terminals must be provided with supplementary software modules. According to US 2002/0060995, the computerized access point moreover has to announce the change to a new radio frequency channel by means of special messages to all terminals. Both resources of the access point as well as resources of the terminals must be used for the quality measurement and for the change of channel.

### DISCLOSURE OF INVENTION

It is an object of the present invention to propose a new computer-based system for dynamic assignment of carrier frequencies to computerized access points of a wireless local area network and a computer program product for control of one or more processors of such a computer-based system, which do not have the drawbacks of the state of the art. In particular, it is an object of the present invention to propose a new computer-based system and a computer program product suitable therefor which enable the dynamic assignment of carrier frequencies to computerized access points of a wireless local area network without software or hardware changes having to be made at the computerized access points of the wireless local area network for this purpose.

These objects are achieved according to the invention in particular throught the elements of the independent claims. Further advantageous embodiments follow moreover from the dependent claims and from the specification.

The above-mentioned objects are achieved by the present invention in particular in that a computer-based system is provided for dynamic assignment of carrier frequencies to the computerized access points of a wireless local area network, which computer-based system is connectible to the computerized access points via a communication connection. According to the invention, the computer-based system is set up to store access point data about the computerized access points, the access point data comprising in each case at least the present carrier frequency of the respective computerized access point. Finally, the computer-based system is set up to determine an optimal carrier frequency for a first of the computerized access points, based on the stored access point data about the computerized access points, and to set the determined optimal carrier frequency at the first computerized access point via the communication connection. By storing the access point data in the computer-based system and by determining the optimal carrier frequencies for the computerized access points in the computer-based system based on the stored access point data, individual, optimized carrier frequencies can be determined for the access points taking into consideration access point data of neighboring access points. This means that, in determining the optimal carrier frequency for a respective access point, not only data about the respective access point, but also data about all access points in the vicinity of the respective access point are also taken into consideration. By determining optimal carrier frequencies in the computer-based system and by setting the determined optimal carrier frequencies in the access points via the communication connection, optimal carrier frequencies can be assigned to the access points without special steps having to be taken for this purpose in the access points or in the terminals of the wireless local area network, additional messages carried out or data captured. This means that the resources of the local mobile radio network do not have to be used to determine and set the optimal carrier frequency.

Preferably, the computer-based system is set up to capture present operational values of the first computerized access point via the communication connection. Without changes to the access points, standard operational values of the access points can thus be captured by the computer-based system via the communication connection, and stored in the computer-based system. Operational values, which are captured by the computer-based system from the computerized access points include, for instance, indications about the present number of users who are associated with the respective computerized access point, about the present number of received faulty data packets in the respective computerized access point and about the present number of received errorless data packets in the respective computerized access point. Preferably, the computer-based system is set up to calculate a weighting factor for the first computerized access point, based on the captured operational values of the first computerized access point, and to store access point data comprising the calculated weighting factor of the first computerized access point and weighting factors of the second computerized access points. The computer-based system is preferably set up to determine the optimal carrier frequency for the first computerized access point based on the stored present carrier frequency of the first computerized access point, based on the stored weighting factors of the second computerized access points and based on the stored present carrier frequencies of the second computerized access points. By determining and storing weighting factors for the computerized access points based on operational values of the access points and by taking into consideration the weighting factors in determining the optimal carrier frequencies, the degree of relevance and influence of a neighboring computerized access point for ascertaining the optimal carrier frequencies can be determined according to defined criteria.

In an embodiment variant, the computer-based system is set up to calculate the weighting factor for the first computerized access point based on a use rate of the first computerized access point, based on a failure rate of the first computerized access point and based on a use probability of the first computerized access point. The computer-based system calculates the weighting factor for an access point based, for example, on the use rate, which is calculated by division of the captured number of users of the first access point by a maximal number of users of the first access point, based on a failure rate, which is calculated by division of the captured number of received faulty data packets at the first access point by the total number of received data packets at the first access point, and based on a use probability, which, according to Poisson, for example, is calculated from stored historical values for the captured number of users of the first access point. The influence of a neighboring access point on the determination of the optimal carrier frequencies can thus be made to depend upon how frequently the respective neighboring access point is used by users with terminals, how much the respective neighboring access point is burdened with failures, and how great the probability is that the respective neighboring access point is used by users with terminals. The use rate is preferably weighted more heavily, e.g. three times as much, than the failure rate and the use probability.

Preferably, the computer-based system is set up to determine the optimal carrier frequency for the first computerized access point in that from among a multiplicity of defined radio frequency channels one radio frequency channel with an assigned carrier frequency is selected such that the sum of the differences between the assigned carrier frequency and the stored present carrier frequencies of the second computerized access points is as large as possible, the differences being weighted in each case by the stored weighting factor of the respective second computerized access point. This means that the optimal carrier frequency, or respectively an optimal radio frequency channel, is determined such that the frequency separation from the carrier frequencies, or respectively radio frequency channels, of neighboring access points is as large as possible, the frequency separation in particular to those neighboring access points having a higher weighting factor being as large as possible, for example because they have a high use rate or a high failure rate.

Preferably, the computer-based system is set up to carry out determination of the optimal carrier frequency for the first computerized access point when captured present operational values of the first computerized access point indicate that the present number of users who are associated with the first computerized access point is zero, and that the present number of received faulty data packets at the first computerized access point exceeds a defined tolerance value. Consequently the carrier frequencies are changed in an access point only when the access point is not being used by users with terminals. In this way signal losses for users during channel change are prevented without special messages having to be sent for this purpose to the terminals of users by the computerized access points, for which the resources of the local mobile radio network would have to be used.

In an embodiment variant, the computer-based system comprises a first autonomous agent module, which is assigned to the first computerized access point, and second autonomous agent modules, which are each assigned to one of the second computerized access points. The first and the second agent modules are each implemented functionally in the same way, and are set up to capture periodically the present operational values via the communication connection, to store the access point data, to determine and set the optimal carrier frequency via the communication connection, and, if applicable, to calculate and store the weighting factors. The agent modules are set up furthermore to exchange the access point data about the assigned computerized access point among the agent modules after a determined optimal carrier frequency has been set in the assigned computerized access point by the channel switching module of the respective agent module, the access point data comprising in each case an access point identification, the present carrier frequency and the calculated weighting factor of the assigned computerized access point. In alternative embodiment variants, the first autonomous agent module and the second autonomous agent modules are each implemented on a separate computer, the separate computers being connected to one another via a communication connection, or the first autonomous agent module and/or at least some of the second autonomous agent modules are implemented on a common computer. The assignment of autonomous agent modules to the computerized access points makes possible the automatic and independent monitoring of each individual computerized access point, the exchange among the agent modules of present carrier frequencies and weighting factors, which are based on operational values of the computerized access points captured during the autonomous and independent monitoring, and the systematic determination of optimal carrier frequencies based on the exchanged carrier frequencies and weighting factors by the autonomous agent modules in each case for the computerized access point accessed to them.

In an embodiment variant, the computer-based system is set up to store historical access point data about the computerized access points. In this embodiment variant, the computer-based system is set up not to exchange access point data about the computerized access points among the agent modules when the stored access point data of the agent module that is assigned to the access point in which a determined optimal carrier frequency was set coincides with historical access point data. By comparison of access point data after the setting of the determined optimal carrier frequency with historical access point data it can be determined whether a particular configuration of the access points has been repeated, i.e. whether the same carrier frequencies, or respectively the same radio frequency channels have already been assigned earlier to the access points in the same way. By the exchange of access point data among the agent modules being omitted when the configuration of the access points corresponds to a historical configuration, the cycles of the optimization process can thereby be prevented from constantly repeating themselves.

### BRIEF DESCRIPTION OF DRAWINGS

An embodiment of the present invention will be described in the following with reference to an example. The example of the embodiment will be illustrated by the following attached figures:

FIG. 1 shows a block diagram representing schematically a wireless local area network with a multiplicity of computerized access points, which are connected to a computer-based system according to a first embodiment.

FIG. 2 shows a block diagram, representing schematically a wireless local area network with a multiplicity of computerized access points which are connected to a computer-based system according to a second embodiment variant.

FIG. 3 shows a block diagram representing schematically an autonomous agent module of the computer-based system.

FIG. 4 shows a flow chart indicating schematically the course of the method in an autonomous agent module of the computer-based system.

### MODES FOR CARRYING OUT THE INVENTION

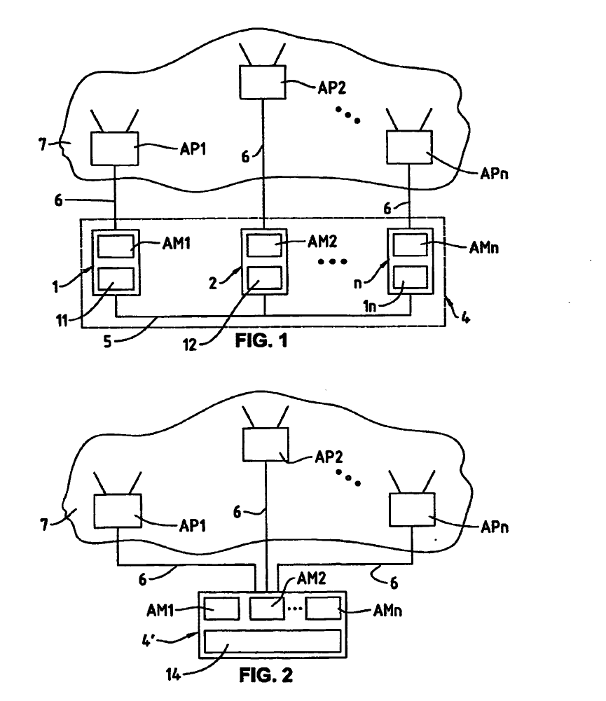

In FIGS. 1 and 2, same components corresponding to one another are designated by same reference symbols.

The reference numeral 7 in FIGS. 1 and 2 designates a wireless local area network, a so-called WLAN. The reference symbols AP1, AP2 and APn designate computerized access points, so-called APs, to the wireless local area network 7, which enable access to the wireless local area network 7 for users with corresponding radio-based communication terminals.

As is shown in FIGS. 1 and 2, the computerized access points AP1, AP2, APn are connected via communication connections 6 to the computer-based systems 4, respectively 4′. The communication connections 6 are contact-based connections, such as communication bus connections or fixed net connections, or wireless connections, which enable in each case the exchange of data between one of the access points AP1, AP2, APn and the computer-based system 4, 4′. The computer-based systems 4 and 4′ are set up for the dynamic assignment of carrier frequencies, or respectively radio frequency channels, to the computerized access points AP1, AP2, APn of the wireless local area network 7, as will be described in more detail in the following paragraphs.

The computer-based system 4 according to first embodiment variant shown in FIG. 1 comprises a multiplicity of computers 1, 2, n, which are connected to one another via a communication connection 5. The communication connection 5 is a fixed net connection or a wireless connection, which enables in each case the data exchange between the computers 1, 2 and n. The computers 1, 2, n each comprise a communication module for the data exchange between the computers 1, 2, n via the communication connection 5, and for the data exchange with the computerized access points AP1, AP2, APn via the communication connections 6, for instance based on the so-called Simple Mail Transfer Protocol (SMTP). The computers 1, 2, n each further comprise an autonomous agent module AM1, AM2, AMn and an agent platform 11, 12, 1n belonging thereto. The autonomous agent modules AM1, AM2, AMn and the agent platforms 11, 12, 1n are preferably implemented as programmed software modules, for instance according to the FIPA specifications (Foundation for Intelligent Physical Agents, see http://www.fipa.org) for co-operation of heterogeneous software agents with the aid of the JADE software platform (Java Agent DEvelopment Framework, see http://sharon.cselt.it/projects/jade).

The computer-based system 4′ according to the second embodiment variant shown in FIG. 2 comprises a computer on which the autonomous agent modules AM1, AM2, AMn are implemented on a common agent platform 14. The common agent platform 14 is preferably implemented, like the autonomous agent modules AM1, AM2, AMn, as programmed software module, for instance according to the FIPA specifications with the aid of the JADE software platform. The computer 4 further comprises a communication module for data exchange with the computerized access points AP1, AP2, APn, via the communication connections 6, for example based on SMTP.

The autonomous agent modules AM1, AM2, AMn and the agent platforms 11, 12, 1n, respectively 14 are preferably implemented on a computer program product comprising a computer-readable medium with computer program code means contained therein for control of one or more processors of the computer-based system 4 respectively 4′.

Both in the first embodiment variant according to FIG. 1 and in the second embodiment variant according to FIG. 2 the autonomous agent modules AM1, AM2, AMn are each assigned to one of the access points AP1, AP2, APn.

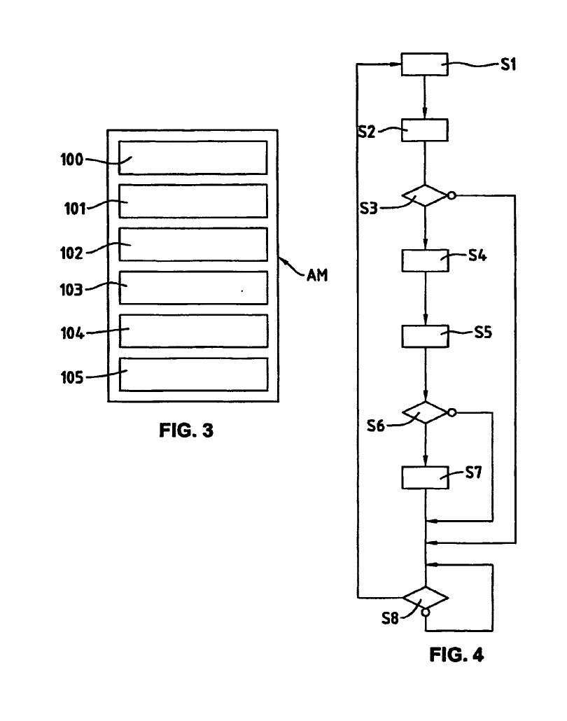

Shown schematically in FIG. 3 is an autonomous agent module AM, which is implemented in the same way as the autonomous agent modules AM1, AM2, AMn. The agent module AM comprises (like the agent modules AM1, AM2 and AMn) an optimization module 100, a channel switching module 101, a weighting module 102, a monitoring module 103, an update module 104 and a memory module 105.

In the following paragraphs, with reference to FIG. 4, the functionality of the autonomous agent modules AM, AM1, AM2, AMn and their modules will be described using the example of the course of the method in one of the autonomous agent modules AM1, AM2, AMn of the computer-based system 4, 4′.

In step S1, the monitoring module 103 of the agent module AM1, AM2, AMn captures present operational values of the assigned access point AP1, AP2, APn. Via the communication connection 6, the operational values are thereby read by the monitoring module 103 from the so-called Management Information Database (MIB) of the assigned access point AP1, AP2, APn, and are stored in the respective agent module AM1, AM2, AMn. Corresponding to the examples shown in FIGS. 1 and 2, operational values of the access point AP1 are thus stored in the agent module AM1, operational values of the access point AP2 in the agent module AM2, and operational values of the access point APn in the agent module AMn. The monitoring module 103 thus captures present operational values indicating the present number of users of the assigned access point AP1, AP2, APn, indicating the present number of received faulty data packets in the assigned access point AP1, AP2, APn, and indicating the present number of received errorless data packets in the assigned access point AP1, AP2, APn.

In step S2, the weighting module 102 of the agent module AM1, AM2, AMn, calculates a weighting factor for the assigned access point AP1, AP2, APn, based on the present operational values captured in step S1. The weighting module 102 calculates the weighting factor for the assigned access point AP1, AP2, APn, based on a use rate for the assigned access point AP1, AP2, APn, based on a failure rate for the assigned access points AP1, AP2, APn, and based on a use probability for the assigned access point AP1, AP2, APn. In so doing the weighting module 102 calculates the use rate for the assigned access point AP1, AP2, APn through division of the present number of users of the assigned access point AP1, AP2, APn captured in step S1 by the maximal number of users of the assigned access point AP1, AP2, APn. The weighting module 102 calculates the failure rate of the assigned access point AP1, AP2, APn through division of the present number of received faulty data packets in the assigned access point AP1, AP2, APn, which number was captured in step S1, by the total number of received data packets in the assigned access point AP1, AP2, APn. The weighting module 102 calculates the use probability for the assigned access point AP1, AP2, APn as probability from the distribution of stored historical values of the captured number of users of the assigned access point AP1, AP2, APn. Finally, the weighting module 102 passes on the calculated weighting factor for the assigned access point AP1, AP2, APn to the memory module 105 of the respective agent module AM1, AM2 AMn for storage. For example, the weighting module of the agent module AM2 calculates the weighting factor for the assigned access point AP2 based on the use rate for the assigned access point AP2, based on the failure rate for the assigned access point AP2, and based on the use probability for the assigned access point AP2, and has the calculated weighting factor stored locally in the memory module 105 of the agent module AM2. The weighting factor wᵢ for the access point i is calculated from the triple-weighted value for the use rate uᵢ of the access point i, from the value for the failure rate rᵢ of the access point I, and from the value for the use probability pᵢ for the access point I, according to the formula (1):

$${w}_{i} = \frac{3 {u}_{i} + {r}_{i} + {p}_{i}}{5} \qquad ( 1 )$$

In step S3, the monitoring module 103 of the agent module AM1, AM2, AMn analyzes whether the present number of users of the assigned access point AP1, AP2, APn, captured in step S1, is zero, and whether the present number of received faulty data packets in the assigned access point AP1, AP2, APn, captured in step S1, exceeds a defined tolerance value. If the analysis turns out to be negative, i.e. if the present number of users of the assigned access point AP1, AP2, APn is greater than zero or the present number of received faulty data packets in the assigned access point AP1, AP2, APn does not exceed the defined tolerance value, the method continues in the agent module AM1, AM2, AMn with step S8. Otherwise, the method continues in the agent module AM1, AM2, AMn with step S4.

In step S4, the optimization module 100 of the agent module AM1, AM2, AMn, determines an optimal carrier frequency, respectively an optimal radio frequency channel for the assigned access point AP1, AP2, APn based on the stored access point data about the access points AP1, AP2, APn. The access point data about the neighboring access points AP1, AP2, APn are stored in the memory module 105, and comprise, in addition to an identification of the respective access point AP1, AP2, APn, the last reported carrier frequency, or respectively the last reported radio frequency channel of the respective access point AP1, AP2, APn, and the last reported weighting factor of the respective access point AP1, AP2, APn. For example, the optimization module 100 of the agent module AM2 determines the optimal carrier frequency, or respectively the optimal radio frequency channel for the assigned access point AP2, based on the present carrier frequency, or respectively on the present radio frequency channel of the assigned access point AP2, from the present carrier frequencies, or respectively present radio frequency channels of the neighboring access points AP1, APn, and from the weighting factors of the neighboring access points AP1, APn. The optimization module 100 thereby determines the optimal carrier frequency for the assigned access point AP2, in that from among a multiplicity of defined radio frequency channels a radio frequency channel with an assigned carrier frequency is selected such that the sum of the differences between the carrier frequency of the selected radio frequency channel and the stored, last reported carrier frequencies of the neighboring access points AP1 and APn is as great as possible, the differences being weighted in each case by the stored last reported weighting factor for the respective neighboring access point AP1, APn. The formula (2) indicates the optimization function fₒₚₜ(i) for the access point i, wⱼ being the weighting factor of the neighboring access point j, and Δ(i, j) being the difference between the carrier frequency of the access point i and the carrier frequency of the neighboring access point j:

$${f}_{opt} ( i ) = {\sum }_{j} {w}_{j} Δ ( i , j ) \qquad ( 2 )$$

In step S5, the channel switching module 101 of the agent module AM1, AM2, AMn sets the optimal carrier frequency, determined in step S4, or respectively the determined optimal radio frequency channel in the assigned access point AP1, AP2, APn. The determined optimal carrier frequency, respectively the determined optimal radio frequency channel is thereby written by the channel switching module 101, via the communication connection 6, in the MIB of the assigned access point AP1, AP2, APn. Finally, the channel switching module 101 passes on the set optimal carrier frequency, respectively the set optimal radio frequency channel to the memory module 105 of the respective agent module AM1, AM2 AMn for storage. For example, the channel switching module 101 of the agent module AM2 writes the optimal carrier frequency, determined in step S4, respectively the determined optimal radio frequency channel in the MIB of the assigned access point AP2, and has the determined optimal carrier frequency, respectively the determined optimal radio frequency channel stored locally in the memory module 105 of the agent module AM2.

In step S6, the channel switching module 101 of the agent module AM1, AM2, AMn compares the stored access point data about the access points AP1, AP2, APn with stored historical access point data about the access points AP1, AP2, APn. In particular, the channel switching module 101 of the agent module AM1, AM2, AMn compares the carrier frequencies, stored as access point data, or respectively the radio frequency channels, which are assigned to the access points AP1, AP2, APn, with carrier frequencies or respectively radio frequency channels, which are stored as historical access point data, and which indicate past configurations of the assignment of carrier frequencies or respectively radio frequency channels to the access points AP1, AP2, APn. For example, the channel switching module 101 of the agent module AM2 compares the carrier frequencies stored in the local memory module 105, or respectively radio frequency channels, which are assigned to the access points AP1, AP2, APn, with historical carrier frequencies, or respectively radio frequency channels, which are stored in the local memory module 105 and indicate past configurations of the assignment of carrier frequencies, or respectively radio frequency channels, to the access points AP1, AP2, APn. If the present carrier frequencies or respectively radio frequency channels, which are assigned to the access points AP1, AP2, APn according to the stored access point data, coincide with a set of historical carrier frequencies, or respectively radio frequency channels, which were assigned earlier to the access points AP1, AP2, APn according to the stored historical access point data, the method continues in the agent module AM1, AM2, AMn (in the selected example in the AM2) with step S7. Otherwise, if the carrier frequencies or respectively radio frequency channels were not yet assigned previously in the present configuration to the access points AP1, AP2, APn, the method continues in the agent module AM1, AM2, AMn (in the selected example in the AM2) with step S8.

TABLE 1

| | | Carrier frequency | | | Number | Number |
|---|---|---|---|---|---|---|
| Access point data in | | radio frequency | Weighting | Number of | of faulty | errorless |
| the agent module AM2 | Identification | channel | factor | users | packets | packets |
| assigned access point | AP2 | a | w₂ | x | y | z |
| neighboring access point | AP1 | b | w₁ | — | — | — |
| neighboring access point | APn | c | wₙ | — | — | — |

In step S7, the update module 104 of the agent module AM1, AM2, AMn transmits present access point data to the agent modules AM1, AM2, AMn, which are assigned to the neighboring access points AP1, AP2, APn. The agent modules AM1, AM2, AMn of the neighboring access points AP1, AP2, APn store the received access point data in each case in the local memory module 105. In particular the update module 104 of the agent module AM1, AM2, AMn transmits, in step S7, the identification of the assigned access point AP1, AP2, APn, the weighting factor of the assigned access point AP1, AP2, APn, calculated in step S2, and the optimal carrier frequency (respectively the optimal radio frequency channel) determined in step S4 and set in the assigned access point AP1, AP2, APn in step S5, to the agent modules AM1, AM2, AMn of the neighboring access points AP1, AP2, APn. For example, the update module 104 of the agent module AM2 transmits the identification of the assigned access point AP2, the weighting factor of the assigned access point AP2, calculated in step S2, and the optimal carrier frequency (respectively the optimal radio frequency channel), determined in step S4 and set in the assigned access point AP2 in step S5, to the agent modules AM1 and AMn of the neighboring access points AP1 or respectively APn.

Shown in Table 1 is an example of the access point data, which are stored in the memory module 105 of the agent module AM2. As shown in Table 1 using the example of the agent module AM2, the access points AP1, AP2, APn (in the example of Table 1 AP2), to which the agent modules AM1, AM2, AMn are assigned (in the example of Table 1 AM2) are correspondingly labeled. As is further shown in Table 1 using the example of the agent module AM2, the neighboring access points AP1, AP2, APn (in the example of Table 1 AP1, APn) are likewise labeled accordingly.

In step S9, the agent module AM1, AM2, AMn, checks, for example on the basis of a temporal value, whether the present operational values of the assigned access points AP1, AP2, APn must be monitored again, and continues, if applicable, with step S1. For example, the agent module AM2 checks whether the present operational values of the assigned access points AP2 must be monitored again, and continues, if applicable, with step S1.

1-18. (canceled)

19. A computer-based system for dynamic assignment of carrier frequencies to computerized access points of a wireless local area network, comprising:
a communication module for connection of the computer-based system via a communication connection to the computerized access points;
a memory module for storing access point data about the computerized access points, which access point data comprises in each case at least a present carrier frequency of the respective computerized access point;
an optimization module for determining a carrier frequency for a first of the computerized access points, based on the stored access point data about the computerized access points;
a channel switching module for setting the determined carrier frequency in the first computerized access point via the communication connection; and
means for calculating weighting factors for the computerized access points, each based on captured operational values of the respective computerized access point,
wherein
the memory module is configured to store access point data comprising the calculated weighting factors of the computerized access points, and
the optimization module is configured to determine the carrier frequency for a first computerized access point from among a multiplicity of defined radio frequency channels, one radio frequency channel with an assigned carrier frequency is selected such that the sum of the differences between the assigned carrier frequency and the stored present carrier frequencies of the second computerized access points is as large as possible, the differences being weighted in each case using the stored weighting factor for the respective second computerized access point.

20. A computer-based system according to claim 19, further comprising a monitoring module for capturing present operational values of the first computerized access point via the communication connection

21. A computer-based system according to claim 19, wherein the means for calculating weighting factors is configured to calculate the weighting factor for the first computerized access point based on a use rate for the first computerized access point, based on a failure rate for the first computerized access point, and based on a use probability for the first computerized access point.

22. A computer-based system according to claim 20, wherein the monitoring module is configured to capture a present operational value of the first computerized access point indicating a present number of users who are associated with the first computerized access point, to capture a present operational value of the first computerized access point indicating a present number of received faulty data packets at the first computerized access point, and to capture a present operational value of the first computerized access point indicating a present number of received errorless data packets at the first computerized access point.

23. A computer-based system according to claim 22, wherein the means for calculating weighting factors is configured to calculate the weighting factor for the first computerized access point, based on a use rate which is calculated by dividing a captured number of users of the first computerized access point by a maximal number of users of the first computerized access point, based on a failure rate, which is calculated by dividing a captured number of received faulty data packets at the first computerized access point by a total number of received data packets at the first computerized access point, and based on a use probability which is calculated from stored historical values for the captured number of users of the first computerized access point.

24. A computer-based system according to claim 19, configured to activate the optimization module for determining the carrier frequency of the first computerized access point when captured present operational values of the first computerized access point indicate that a present number of users who are associated with the first computerized access point is zero, and that a present number of received faulty data packets at the first computerized access point exceeds a defined tolerance value.

25. A computer-based system according to claim 20, further comprising:
a first autonomous agent module, which is assigned to the first computerized access point; and
second autonomous agent modules, which are each respectively assigned to one of the second computerized access points;
wherein the first and the second agent modules are each implemented functionally in a same way, and comprise a monitoring module, a memory module, means for calculating weighting factors, an optimization module, a channel switching module, and an update module, which update module is configured to exchange the access point data about the assigned computerized access point among the agent modules, the access point data comprising in each case an access point identification, a present carrier frequency and a calculated weighting factor of the assigned computerized access point, wherein the agent modules are each configured to activate the monitoring module of the respective agent module periodically to capture present operational values in the associated computerized access point, and wherein the agent modules are each configured to activate the update module of the respective agent module for the exchange of the access point data after a determined carrier frequency has been set by the channel switching module of the respective agent module in the associated computerized access point.

26. A computer-based system according to claim 25, wherein the memory module is configured to store historical access point data about the computerized access points, and wherein the agent modules are each configured not to activate the update module of the respective agent module for an exchange of the access point data if the stored access point data of the respective agent module coincide with historical access point data of the respective agent module.

27. A computer-based system according to claim 25, wherein the first autonomous agent module and the second autonomous agent modules are each implemented on a separate computer, the separate computers being connected to one another via a communication connection.

28. A computer-based system according to claims 25, wherein the first autonomous agent module and/or at least some of the second autonomous agent modules are implemented on a common computer.

29. A computer program product comprising:
a computer-readable medium with computer program code means contained therein for control of one or more processors of a computer-based system for dynamic assignment of carrier frequencies to computerized access points of a wireless local area network that are connectible to the computer-based system via a communication connection such that:
access point data about the computerized access points are stored in the computer-based system, which access point data each comprises at least a present carrier frequency of the respective computerized access point,
a carrier frequency for a first of the computerized access points is determined by the computer-based system, based on the stored access point data about the computerized access points, and
the determined carrier frequency is set in the first computerized access point by the computer-based system via the communication connection,
wherein
the computer program product comprises further computer program code means which control the processors of the computer-based system such that:
a weighting factor is calculated by the computer-based system for the computerized access points based in each case on captured operational values of the respective computerized access point,
access point data are stored in the computer-based system which comprise the calculated weighting factors of the computerized access points, and
the carrier frequency for the first computerized access point is determined by the computer-based system from among a multiplicity of defined radio frequency channels one radio frequency channel with an assigned carrier frequency is selected such that the sum of the differences between the assigned carrier frequency and the stored present carrier frequencies of the second computerized access points is as large as possible, the differences being weighted in each case using the stored weighting factor for the respective second computerized access point.

30. A computer program product according to claim 29, further comprising further computer program code means that control the processors of the computer-based system such that present operational values of the first computerized access point are captured by the computer-based system via the communication connection.

31. A computer program product according to claim 29, further comprising further computer program code means that control the processors of the computer-based system such that the weighting factor for the first computerized access point is calculated by the computer-based system based on a use rate for the first computerized access point, based on a failure rate for the first computerized access point, and based on a use probability for the first computerized access point.

32. A computer program product according to claim 29, further comprising further computer program code means that control the processors of the computer-based system such that a present operational value for the first computerized access point is captured by the computer-based system indicating a present number of users who are associated with the first computerized access point, wherein a present operational value for the first computerized access point is captured by the computer-based system indicating a present number of faulty data packets received at the first computerized access point, and wherein a present operational value for first computerized access point is captured by the computer-based system indicating a present number of errorless data packets received at the first computerized access point.

32. A computer program product according to claim 32, further comprising further computer program code means that control the processors of the computer-based system such that the weighting factor for the first computerized access point is calculated based on a use rate, which is calculated by division of a captured number of users of the first computerized access point by a maximal number of users of the first computerized access point, based on a failure rate which is calculated by division of a captured number of received faulty data packets at the first computerized access point by the total number of received data packets at the first computerized access point, and based on a use probability which is calculated from stored historical values for a captured number of users of the first computerized access point.

34. A computer program product according to claim 29, further comprising further computer program code means that control the processors of the computer-based system such that the computer-based system carries out the determination of the carrier frequency of the first computerized access point if captured present operational values of the first computerized access point indicate that a present number of users who are associated with the first computerized access point is zero, and that a present number of received faulty data packets at the first computerized access point exceeds a defined tolerance value.

35. A computer program product according to claim 29, further comprising further computer program code means that control the processors of the computer-based system such that the computer-based system acts as a first autonomous agent module, which is assigned to the first computerized access point, wherein the computer-based system acts as second autonomous agent modules which are each assigned to one of the second computerized access points, wherein the computer-based system periodically captures present operational values of the computerized access points, to which agent modules are assigned, wherein access point data about the computerized access points are exchanged by the computer-based system among the agent modules after the determined carrier frequency has been set in a computerized access point, to which an agent module is assigned, by the computer-based system, the access point data each comprising an access point identification, the present carrier frequency, and the calculated weighting factor of the respective computerized access point.

36. A computer program product according to claim 35, further comprising further computer program code means that control the processors of the computer-based system such that in the computer-based system historical access point data about the computerized access points are stored, and wherein access point data about the computerized access points are not exchanged by the computer-based system among the agent modules if the stored access point data of the agent module which is assigned to the access point, in which a determined carrier frequency was set, coincide with historical access point data.
